(19) United States
(12) Patent Application Publication
(10) Pub. No.: US 2025/0015997 A1
(43) Pub. Date: Jan. 9, 2025

(54) AUTOMATED VIDEO CLIP NON-FUNGIBLE TOKEN (NFT) GENERATION

(71) Applicant: NAGRAVISION SARL, CHESEAUX-SUR-LAUSANNE (CH)

(72) Inventor: Ryan Spanier, Atlanta, GA (US)

(73) Assignee: NAGRAVISION SARL, CHESEAUX-SUR-LAUSANNE (CH)

(21) Appl. No.: 18/710,923

(22) PCT Filed: Aug. 19, 2022
(86) PCT No.: PCT/US2022/040881

§ 371 Date: May 16, 2024

Related U.S. Application Data
(60) Provisional application No. 63/282,422, filed on Nov. 23, 2021.

(51) Int. Cl. H04L 9/32; G06Q 30/0283; H04N 21/2187; H04N 21/234

(52) U.S. Cl. CPC H04L 9/3213; G06Q 30/0283; H04N 21/2187; H04N 21/234

(57) ABSTRACT

Certain aspects of the present disclosure are directed towards a method for non-fungible token processing. The method generally includes identifying a trigger for generating a non-fungible token associated with a video clip, extracting a portion of the video clip in response to identifying the trigger, generating the non-fungible token corresponding to the portion of the video clip, and outputting the non-fungible token for hosting on a platform.

### CROSS-REFERENCE TO RELATED APPLICATION

This application claims priority to provisional patent application U.S. Ser. No. 63/282,422 filed on Nov. 23, 2021, the content of which is incorporated by reference herein in its entirety.

### FIELD

The present disclosure generally relates to non-fungible token processing. For example, aspects of the present disclosure include systems and techniques for automated generation of non-fungible tokens associated with video clips.

### BACKGROUND

A non-fungible token (NFT) is a security including digital data that may be stored in a blockchain. For example, the blockchain may include a distributed ledger that may be use to record ownership of the NFT. The blockchain may be used to transfer ownership of the NFT so that the NFT may be traded. An NFT may include a reference (e.g., a link) to a file such as photos, videos, and audio. NFTs are non-fungible since they are uniquely identifiable.

### SUMMARY

Certain aspects of the present disclosure are directed towards a method for non-fungible token processing. The method generally includes identifying a trigger for generating a non-fungible token associated with a video clip, extracting a portion of the video clip in response to identifying the trigger, generating the non-fungible token corresponding to the portion of the video clip, and outputting the non-fungible token for hosting on a platform.

Certain aspects of the present disclosure are directed towards an apparatus for non-fungible token processing. The apparatus generally includes a memory and one or more processors coupled to the memory. The one or more processors being configured to identify a trigger for generating a non-fungible token associated with a video clip, extract a portion of the video clip in response to identifying the trigger, generate the non-fungible token corresponding to the portion of the video clip, and output the non-fungible token for hosting on a platform.

Certain aspects of the present disclosure are directed towards a non-transitory computer-readable medium having instructions stored thereon, which when executed by one or more processors, cause the one or more processors to: identify a trigger for generating a non-fungible token associated with a video clip; extract a portion of the video clip in response to identifying the trigger; generate the non-fungible token corresponding to the portion of the video clip; and output the non-fungible token for hosting on a platform.

Certain aspects provide a method for non-fungible token processing. The method generally includes obtaining a plurality of non-fungible tokens, wherein each of the plurality of non-fungible tokens corresponds to a portion of a video clip; generating a non-fungible token corresponding to the plurality of non-fungible tokens; and outputting the non-fungible token for hosting on a platform.

Certain aspects provide an apparatus for non-fungible token processing. The apparatus generally includes a memory and one or more processors, the one or more processors being configured to obtain a plurality of non-fungible tokens, wherein each of the plurality of non-fungible tokens corresponds to a portion of a video clip, generate a non-fungible token corresponding to the plurality of non-fungible tokens, and output the non-fungible token for hosting on a platform.

Certain aspects provide a non-transitory computer-readable medium having instructions stored thereon, which when executed by one or more processors, cause the one or more processors to obtain a plurality of non-fungible tokens, wherein each of the plurality of non-fungible tokens corresponds to a portion of a video clip, generate a non-fungible token corresponding to the plurality of non-fungible tokens, and output the non-fungible token for hosting on a platform.

Certain aspects provide a method for non-fungible token processing. The method generally includes obtaining a non-fungible token corresponding to a video clip; generating a plurality of non-fungible tokens, wherein each of the plurality of non-fungible tokens corresponds to a portion of the video clip; and outputting the plurality of non-fungible tokens for hosting on a platform.

Certain provide an apparatus for non-fungible token processing. The apparatus generally includes a memory and one or more processors, the one or more processors being configured to obtain a non-fungible token corresponding to a video clip, generate a plurality of non-fungible tokens, wherein each of the plurality of non-fungible tokens corresponds to a portion of the video clip, and output the plurality of non-fungible tokens for hosting on a platform.

Certain aspects provide a non-transitory computer-readable medium having instructions stored thereon, which when executed by one or more processors, cause the one or more processors to obtain a non-fungible token corresponding to a video clip, generate a plurality of non-fungible tokens, wherein each of the plurality of non-fungible tokens corresponds to a portion of the video clip, and output the plurality of non-fungible tokens for hosting on a platform.

### BRIEF DESCRIPTION OF THE DRAWINGS

Illustrative embodiments of the present application are described in detail below with reference to the following drawing figures:

FIG. 1 illustrates example operations for non-fungible token (NFT) generation, in accordance with certain aspects of the present disclosure.

FIG. 2 is a diagram illustrating an example NFT system, in accordance with certain aspects of the present disclosure.

FIG. 3 illustrates markers overlayed on a track slider for a video stream, in accordance with certain aspects of the present disclosure.

FIG. 4 is a flow diagram illustrating example operations for NFT processing, in accordance with certain aspects of the present disclosure.

FIG. 5 illustrates example operations for NFT processing, in accordance with certain aspects of the present disclosure.

FIG. 6 illustrates example operations for NFT processing, in accordance with certain aspects of the present disclosure.

FIG. 7 illustrates an example architecture of a computing system.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

The creation, listing, and curation of non-fungible tokens (NFT) are complex processes. The barrier to entry currently involves blockchain and NFT knowledge. The cost for listing an NFT is high, which prevents the generation of NFTs at any reasonable scale. Related to that, there is significant investment creators must put forward to start listing NFTs relative to their short-term revenue expectations.

There are unique challenges for NFTs for video clips, especially clips which are live streams. Creators typically want the process to be as fast and seamless as possible to encourage impulse buying and reduce the barrier to entry for their supporters. This means relevant video clips should be identified and transferred to the NFT before support has lost interest in the particular moment. Systems and techniques are described herein that provide a pipeline tied in or integrated with a platform (e.g., a software-as-a-service (SaaS) based platform such as a video streaming platform). Various aspects associated with the systems and techniques are described below with respect to the figures.

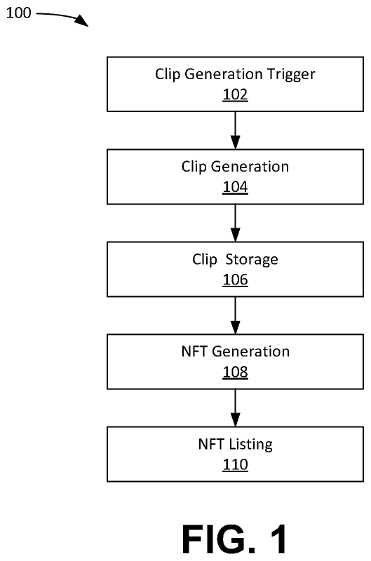

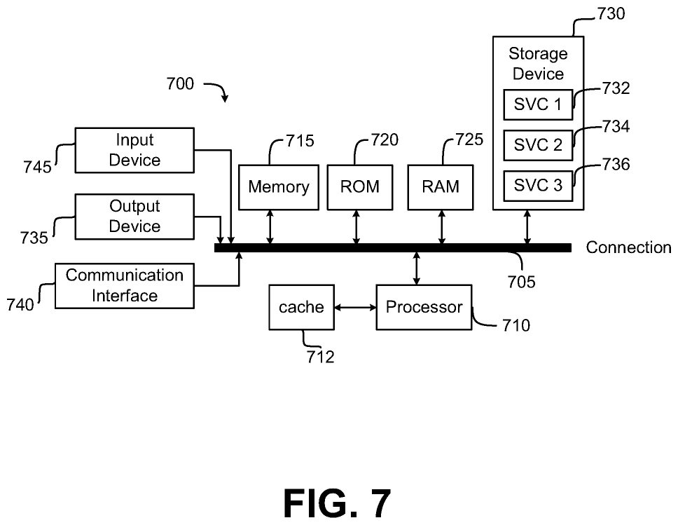

FIG. 1 illustrates example operations 100 for NFT generation, in accordance with certain aspects of the present disclosure. The operations 100 may be performed by an NFT system, which may include a processor (e.g., processor 710 of FIG. 7), and in some aspects, a storage device (e.g., storage device 730).

In some aspects, the operations 100 may include, at block 102, the NFT system obtaining a clip generation trigger. The clip generation trigger may be any suitable trigger such as detection of a particular event or a manual trigger input from a user. As an example, during a first-person shooter game, there may be triggers the game generates for notable events. These could be a kill, a death, a win, or a flag capture. The triggers are generated by the game and may be captured by the NFT system for clip generation, described herein. In some cases, clip generation may be triggered by a threshold of audience members asking for a clip of a certain time frame. In response, the clip may be generated on demand due to the literal demand of the audience members. The NFT system may facilitate triggering by a moderator or even a video processing artificial intelligence (AI) that identifies a notable clip.

Once a trigger has been obtained, the NFT system generates a video clip (e.g., also referred to herein as a “clip” for short) at block 104. For example, the live or recorded video stream may be obtained, and in some aspects, a portion of the video stream may be extracted as a clip for an NFT in response to the trigger obtained at block 102. In some cases, the trigger may indicate the portion of the video stream to be extracted. In some cases, the generated clip may be stored at block 106. The clip may be stored so that a generated NFT can include a link to the clip for retreival. At block 108, based on the generated clip, an NFT may be generated, and at block 110, listed on an NFT platform for sale.

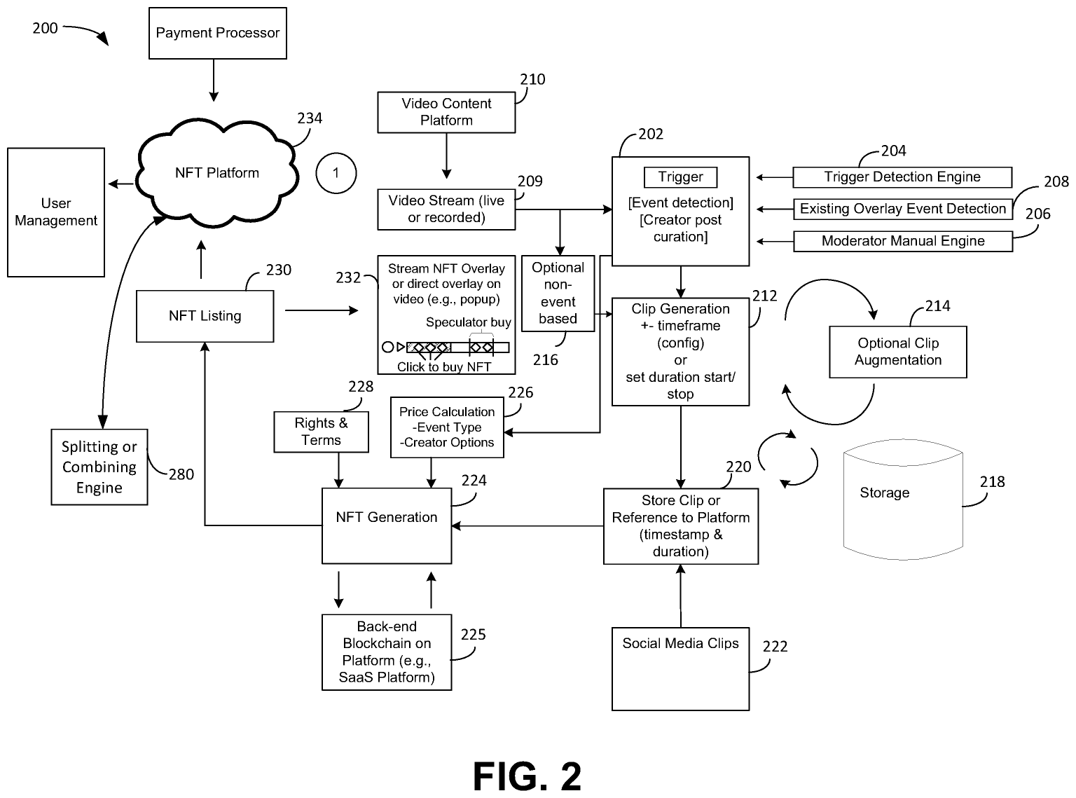

FIG. 2 is a diagram illustrating an example NFT system 200, in accordance with certain aspects of the present disclosure. In some aspects of the present disclosure, the NFT system 200 may generate a video clip for NFT generation (e.g., as described with respect to block 104 of FIG. 1). In one illustrative example, at block 202, the generation of the video clip for NFT generation may be triggered as described with respect to block 102 of FIG. 1. The video clip may include a live or recorded video stream 209, which may be received from a video platform 210 (e.g., a video streaming platform). In some aspects, a trigger detection engine 204 may detect a particular trigger event, and provide an indication of the event to initiate generation of a clip for an NFT. The trigger may be any input indicating to the system to generate a clip. The trigger can be based on a unique or new event, such as an interesting sports or e-sports play (e.g., a goal being scored during a real sports or e-sports event), a character moment during a show or movie (e.g., a first kiss or accomplishment), or other event. The trigger can be automatically generated or manually specified.

In some implementations, an automated trigger may be generated. In one example, event detection may be performed for well-known content (e.g., esports or sports) where important events are automatically detected and used for generating an NFT. The event detection source can be in stream or out of stream. For in stream, the system may detect what is occurring in the video stream and trigger an event for the NFT system.

At block 208, the NFT system may use existing overlays to perform event detection. For example, for out of stream (e.g., non-live video stream), the NFT system can use events in other data streams such as goal line technology (e.g., indicating that a goal has occurred in a sports event), triggers from an application programming interface (API) such as a game engine or software running on the content creator's computer or computing system, or other data feeds such as weather or Internet-of-Things (IoT) devices to identify clips (or portions of clips) that may be candidates for NFT.

In some aspects, a moderator manual engine 206 may be used for manual triggering of NFT generation. For manually defined triggers (e.g., by a user or moderator), instead of an automated trigger, users may request a clip manually. For example, for pre-recorded content, a content moderator may specify via a graphical user interface (GUI) the parts of a video they believe will be most interesting for NFT clips. This may allow the content creator to curate the clip, capturing the important moments and lead up times. In some aspects, an NFT may be requested while content is being consumed, either live or pre-recorded. A moderator may manage the identification of the trigger by identifying interesting events. In some cases, followers, supporters, customers, or other users may directly request NFT creation using the NFT system 200.

In some cases, the NFT system 200 may provide, at block 216, non-event-based periodic clip generation. For instance, a content creator may specify how often and for how long clips should be generated. In one example, a content creator can cause the system to create 30-second NFT clips for an entire video with no overlap. In another example, a content creator can cause the system to create 30 second clips with 10 seconds of overlap on either end.

Once a trigger is received, a clip generation engine can determine, at block 212, the timeframe, duration, or quality for generating a clip. In some cases, settings for generating an NFT may be trigger or event-dependent. For example, for specific types of events (e.g., an eSports first-person shooter (FPS) kill event), the system can capture 5 seconds before and after a detected event. For enhanced or special events (e.g., an eSports victory event), the system may capture 20 seconds before and 20 seconds after.

In some aspects, at block 214, the NFT system may perform clip augmentation to augment clips. For example, a content creator may augment each clip with additional content, such as a seal of authenticity/watermark, a signature overlay, or a serial number. The buyer of an NFT may also use the NFT system to perform overall augmentation with their screen name, date, or other unique details.

In certain aspects, the NFT system 200 may store clips in storage 218 at block 220. For example, NFTs may not actually store media, but rather serve as unique pointers to media content. The NFT system described herein may provide multiple storage options. In some cases, two or more of the multiple storage options can be combined. One example of a storage option is a distributed or content delivery network (CDN) backed storage (e.g., using a group of geographically distributed servers). The CDN backed storage can provide high quality content with streaming capability world-wide. Another storage option that may be used by the system is an inter planetary file system (IPFS). IPFS can provide a distributed option for those seeking no centralized service dependency. Another example of a storage option that can be used by the system includes long term storage. Long term storage can provide storage over a long period of time (e.g., over many years). Another storage option that can be used by the system is cloud based storage, where the content can be stored on a cloud file storage provider. As opposed to external storage, the clip may be only referenced in the content creator platform, in some aspects. For instance, some platforms may provide long term storage options for content creators. Some aspects of the present disclosure may provide links to and specify clips (e.g., using an API with time start/stop options) to content stored on other platforms.

In some aspects, video clips may be stored from various online sources. For example, social media clips 222 may be received at stored in storage 218 as candidates for NFT generation, as described in more detail herein.

At block 224, the NFT system may then generate one or more NFTs based on one or more of the stored video clips. For example, once one or more clips or media and any storage options have been defined, the system may generate one or more NFT. The NFT may be generated using a back-end blockchain 225 on a platform (e.g., SaaS platform). For instance, the NFT may be recorded in a legger of a blockchain.

In some cases, other options may be provided for the creator and may be configured during account setup or configured uniquely for each channel, clip, or video. One example of an option is the price of an NFT. At block 226, the NFT system may determine (e.g., calculate) a price for an NFT generated at block 224. The price of the NFT may be set at the initial creation of the NFT, in some aspects. In some cases, an NFT may be created and not sold, and thus, no price may be set for some NFTs. In some aspects, each NFT may be provided for purchase (e.g., as an auction or direct buy). The content creator may set pricing and payment options. In some cases, automated pricing may be applied to one or more NFTs, in which case the system may determine a suggested price of one or more NFTs for the content creator. In some aspects, to automatically determine a price, the system may consider the popularity of the creator, the current user count and quality on the stream, the triggered event/description, and/or other clip qualities. An objective of the NFT system when setting an NFT price may be to set an attractive initial price (e.g., for an auction or direct sale) to help increase profits for the creator and the platform.

The system may also determine rights and terms 228 associated with the generated NFT. Various rights can be granted to the NFT holder. A rights and terms engine can mark an NFT appropriately for the options the creator selected.

Uniqueness is another option that may be configured for a particular NFT. For instance, an NFT may be unique, but does not have to be unique. In one example, the NFT system may create a number of copies of each NFT. The content creator may designate each copy of each NFT with a unique serial number, series number, or other unique number or identifier. The NFT system may overlay with the identifier. The unique identifier (e.g., serial number) associated with a particular NFT may be embedded into the particular NFT, and in some cases may appear as an overlay on the video associated with a particular NFT.

At block 230, the NFT system may then list the generated NFT. In some aspects, the NFT system may list the NFT on an open NFT marketplace. Another example of a platform to list one or more NFTs is a video streaming platform. Integrated NFT areas may be implemented for each platform for listing of NFTs for sale.

In some aspects, at block 232, the video clip associated with an NFT may be streamed. The listing of the NFT may be overlayed on the video stream. Graphical user interface integrations (e.g., markers or other indications) for NFTs may be overlayed on the video progress bar with the ability for a user to interact with the graphical user interface integrations to click and purchase a particular NFT.

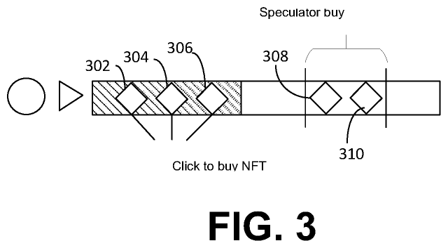

FIG. 3 illustrates markers overlayed on a track slider (also referred to as a seek bar) for a video stream, in accordance with certain aspects of the present disclosure. For example, as the video is being streamed, markers (e.g., markers 302, 304, 306) may be displayed, each corresponding to a portion of the video stream. As shown, the markers 302, 304, 306 may correspond to time periods of the video that have already played. In some cases, marker(s) or other indication(s) may be overlayed on media content (e.g., over live television content for television providers). The marker(s) or other indication(s) can in some cases be a separate widget, window, or other display for consumers and creators in their video platform. In some further examples, a closed ecosystem may also list NFTs in this manner, such as a television provider's user interface. In some cases, the video streaming platform can more generally be a media streaming platform, which can provide media content including video, audio, and/or other media content.

User interface integrations can also be provided, as described above (e.g., a marker can be displayed, overlaid, or otherwise presented with an option to purchase an NFT). In some cases, the system can provide different types of indications of a valuable NFT existing in a media stream (e.g., in a video) and/or the current trading traffic around that NFT. In some aspects, an NFT with a popular bid or large number of bids may be shown in a different color or logo, for example. For example, marker 304 may be presented with a different color than marker 302, indicating the NFT associated marker 304 is more popular.

In some cases, the NFT system may allow users to perform speculative buying of portions of media content as an NFT. For example, speculative buying may be used to support users speculating and purchasing future time windows as an NFT in a stream (e.g., a media stream, such as a video stream) without knowing what content would be present. For example, if watching an eSports streamer, a user can attempt to guess when a match will end if the streamer was victorious. The user can pre-bid or purchase that segment of time hoping there would be good content present at that moment. For example, marker 308 or marker 310 may be selected by a user, each marker corresponding to a time period of the video content that has not yet played on a live stream. The user may purchase the NFT associated with the selected marker in hopes that the corresponding time period for the NFT is valuable.

Referring back to FIG. 2, upon listing an NFT at block 230, the NFT may be hosted on an NFT platform 234. As shown, payment processing may be provided for the NFT platform (e.g., to buy/sell NFTs). The NFTs may be provided for user management (e.g., provide the NFT for a wallet or provide a social account link).

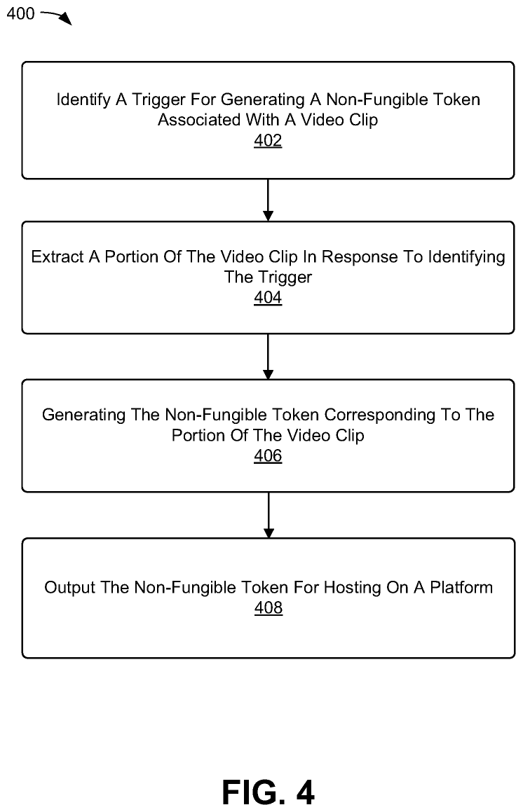

FIG. 4 is a flow diagram illustrating example operations 400 for NFT processing, in accordance with certain aspects of the present disclosure. The operations 400 may be performed, for example, by an NFT system such as a processor (e.g., processor 710), and in some aspects, a memory (e.g., storage device 730).

At block 402, the NFT system may identify a trigger associated with a video clip. Identifying the trigger may include receiving a user input (e.g., indicating to generate an NFT for a portion of the video clip) associated with the video clip. Identifying the trigger may involve determining than an event (e.g., a goal in a sports stream or a kill in an FPS eSport stream) has occurred in the video clip.

At block 404, the NFT system may extract a portion of a video clip in response to identifying the trigger. A duration of the extracted portion of the video clip may be based on a type of the trigger. For instance, for specific types of events (e.g., an eSports FPS kill event), the NFT system may capture 5 seconds before and after a detected event. In another example, for enhanced or special events (e.g., an eSports victory event), the NFT system may capture 20 seconds before and 20 seconds after the event.

At block 406, the NFT system may generate a non-fungible token based on the portion of the video clip. In some cases, the NFT system may augment the portion of the video clip based on user input (e.g., the portion of the video clip may be augmented with an identifier). The NFT may be generated based on the augmented portion of the video clip.

The NFT system may store the portion of the video clip. The NFT may include a pointer to retrieve the stored portion of the video clip. At block 408, the NFT system may output the non-fungible token for hosting on a platform.

In some aspects, the NFT system may determine a price associated with the NFT. The price may be determined based on a popularity associated a creator of the video clip, a quality associated with the video clip, a popularity associated with at least the portion of the video clip, or a description of at least the portion of the video clip. For example, if a particular portion of a video clip is showing high user interest (e.g., as determined based on a comment section of the video stream), the price of the associated NFT may be higher.

In some cases, the NFT system may generate at least one other NFT based on the portion of the video clip. For instance, multiple NFTs may be generated based on the same portion of the video clip (e.g., or overlapping portions of the video clip). In some cases, an identifier (e.g., serial number) may be overlayed on each of the multiple NFTs.

In some aspects, listing the non-fungible token may include providing an overlay on a stream of the video clip indicating availability of the non-fungible token. For example, as described with respect to FIG. 3, markers may be provided that allow purchase of the NFT associated with a portion of the video clip. A visual associated with the overlay may be based on a popularity of the non-fungible token. In some aspects, the video clip may be streamed live. The NFT system may receive a request for purchase of the NFT prior to the live stream of the portion of the video clip. For example, as described with respect to FIG. 3, the user may select (e.g., click on) a marker (e.g., marker 308) prior to the corresponding portion of the video clip has been streamed. In some cases, the NFT system may split an NFT into multiple NFTs. For example, the NFT system may divide the NFT into a plurality NFTs, each of the plurality of NFTs being associated with a respective subportion of the portion of the video clip.

In some cases, the system may allow NFT combinations and/or splitting. For example, as the systems and techniques described herein are related to media clips (e.g., video clips), content owners may want to further segment clips and/or combine their clips. If a user owns continuous NFTs, the platform can support combining those NFTs into a longer segment (e.g., a longer video segment including NFTs associated with individual video clips within the video segment), including all or some of the rights, terms, and purchase rules. A splitting and combination engine 280 may determine if the content creator allows splitting/combining or not and in what terms. In some cases, a content owner (e.g., an owner of a clip associated with an NFT) may further divide a clip into segments for generating multiple corresponding NFTs. The splitting and combination engine 280 may perform the splitting or combining.

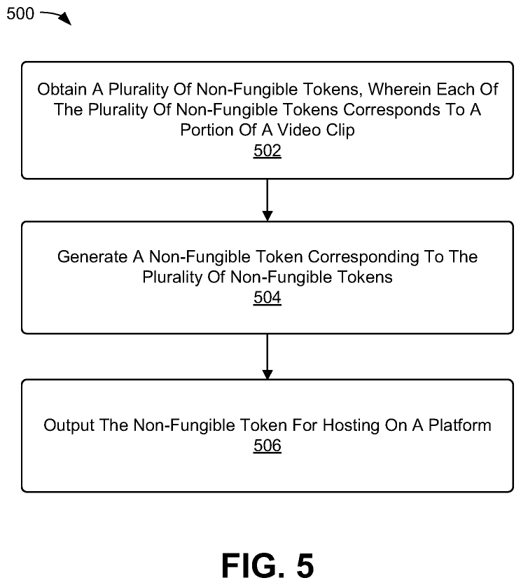

FIG. 5 illustrates example operations 500 for NFT processing, in accordance with certain aspects of the present disclosure. The operations 500 may be performed, for example, by an NFT system such as a processor (e.g., processor 710), and in some aspects, a memory (e.g., storage device 730).

At block 502, the NFT system obtains a plurality of non-fungible tokens. Each of the plurality of non-fungible tokens may correspond to a portion of a video clip (e.g., portions of the same video clip or different video clips). For example, the plurality of non-fungible tokens may correspond to different portions of the same video clip.

At block 504, the NFT system generates a non-fungible token corresponding to the plurality of non-fungible tokens. The non-fungible token may correspond to a concatenation of the portion of the video clip corresponding to each of the plurality of non-fungible tokens. At block 506, the NFT system outputs the non-fungible token for hosting on a platform.

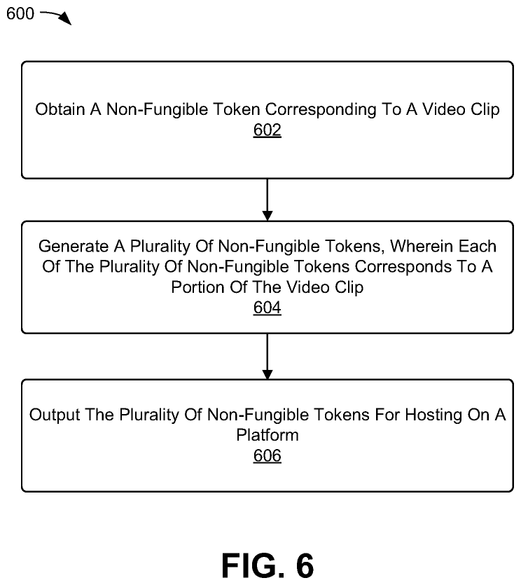

FIG. 6 illustrates example operations 600 for NFT processing, in accordance with certain aspects of the present disclosure. The operations 600 may be performed, for example, by an NFT system such as a processor (e.g., processor 710), and in some aspects, a memory (e.g., storage device 730).

At block 602, the NFT system obtains a non-fungible token corresponding to a video clip. At block 604, the NFT system generates a plurality of non-fungible tokens, wherein each of the plurality of non-fungible tokens corresponds to a portion of the video clip. The portions of the video clip include partially overlapping portions of the video clip. At block 606, the NFT system outputs the plurality of non-fungible tokens for hosting on a platform.

FIG. 7 illustrates an architecture of a computing system 700 wherein the components of the system 700 are in electrical communication with each other using a connection 705, such as a bus. Exemplary system 700 includes a processing unit (CPU or processor) 710 and a system connection 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable client interaction with the computing system 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a client to provide multiple types of input to communicate with the computing system 700. The communications interface 740 can generally govern and manage the client input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

Illustrative Aspects of the present disclosure include:

Aspect 1. A method for non-fungible token processing, comprising: identifying a trigger for generating a non-fungible token associated with a video clip; extracting a portion of the video clip in response to identifying the trigger; generating the non-fungible token corresponding to the portion of the video clip; and outputting the non-fungible token for hosting on a platform.

Aspect 2. The method of claim aspect 1, wherein identifying the trigger comprises receiving a user input associated with the video clip.

Aspect 3. The method of any one of aspects 1-2, wherein identifying the trigger comprises determining that an event has occurred in the video clip.

Aspect 4. The method of any one of aspects 1-3, wherein the trigger associated with the video clip is identified while the video clip is being streamed live.

Aspect 5. The method of any one of aspects 1-4, wherein a duration of the extracted portion of the video clip is based on a type of the trigger.

Aspect 6. The method of any one of aspects 1-5, further comprising augmenting the portion of the video clip based on user input, wherein the non-fungible token is generated based on the augmented portion of the video clip.

Aspect 7. The method of any one of aspects 1-6, further comprising storing the portion of the video clip, wherein the non-fungible token comprises a pointer to retrieve the stored portion of the video clip.

Aspect 8. The method of any one of aspects 1-7, further comprising determining a price associated with the non-fungible token based on at least one of: a popularity associated a creator of the video clip; a quality associated with the video clip; a popularity associated with at least the portion of the video clip; or a description of at least the portion of the video clip.

Aspect 9. The method of any one of aspects 1-8, further comprising generating at least one other non-fungible token based on the portion of the video clip.

Aspect 10. The method of any one of aspects 1-9, wherein listing the non-fungible token comprises providing an overlay on a stream of the video clip indicating availability of the non-fungible token.

Aspect 11. The method of aspect 10, wherein a visual associated with the overlay is based on a popularity of the non-fungible token.

Aspect 12. The method of any one of aspects 1-11, wherein: at least the portion of the video clip is streamed live as a live stream; and identifying the trigger includes receiving a request for purchase of the non-fungible token prior to the live stream of the portion of the video clip.

Aspect 13. The method of any one of aspects 1-12, further comprising dividing the non-fungible token into a plurality non-fungible tokens, each of the plurality of non-fungible tokens is associated with a respective subportion of the portion of the video clip.

Aspect 14. A method for non-fungible token processing, comprising: obtaining a plurality of non-fungible tokens, wherein each of the plurality of non-fungible tokens corresponds to a portion of a video clip; generating a non-fungible token corresponding to the plurality of non-fungible tokens; and outputting the non-fungible token for hosting on a platform.

Aspect 15. The method of aspect 14, wherein the non-fungible token corresponds to a concatenation of the portion of the video clip corresponding to each of the plurality of non-fungible tokens.

Aspect 16. The method of any one of aspects 14-15, wherein the plurality of non-fungible tokens corresponds to different portions of the same video clip.

Aspect 17. A method for non-fungible token processing, comprising: obtaining a non-fungible token corresponding to a video clip; generating a plurality of non-fungible tokens, wherein each of the plurality of non-fungible tokens corresponds to a portion of the video clip; and outputting the plurality of non-fungible tokens for hosting on a platform.

Aspect 18. The method of aspect 17, wherein the portions of the video clip include partially overlapping portions of the video clip.

1. A method for non-fungible token processing, comprising:
identifying a trigger for generating a non-fungible token associated with a video clip;
extracting a portion of the video clip in response to identifying the trigger;
generating the non-fungible token corresponding to the portion of the video clip; and
outputting the non-fungible token for hosting on a platform.

2. The method of claim 1, wherein identifying the trigger comprises receiving a user input associated with the video clip.

3. The method of claim 1, wherein identifying the trigger comprises determining that an event has occurred in the video clip.

4. The method of claim 1, wherein the trigger associated with the video clip is identified while the video clip is being streamed live.

5. The method of claim 1, wherein a duration of the extracted portion of the video clip is based on a type of the trigger.

6. The method of claim 1, further comprising augmenting the portion of the video clip based on user input, wherein the non-fungible token is generated based on the augmented portion of the video clip.

7. The method of claim 1, further comprising storing the portion of the video clip, wherein the non-fungible token comprises a pointer to retrieve the stored portion of the video clip.

8. The method of claim 1, further comprising determining a price associated with the non-fungible token based on at least one of:
a popularity associated a creator of the video clip;
a quality associated with the video clip;
a popularity associated with at least the portion of the video clip; or
a description of at least the portion of the video clip.

9. The method of claim 1, further comprising generating at least one other non-fungible token based on the portion of the video clip.

10. The method of claim 1, wherein listing the non-fungible token comprises providing an overlay on a stream of the video clip indicating availability of the non-fungible token.

11. The method of claim 10, wherein a visual associated with the overlay is based on a popularity of the non-fungible token.

12. The method of claim 1, wherein:
at least the portion of the video clip is streamed live as a live stream; and
identifying the trigger includes receiving a request for purchase of the non-fungible token prior to the live stream of the portion of the video clip.

13. The method of claim 1, further comprising dividing the non-fungible token into a plurality of non-fungible tokens, each of the plurality of non-fungible tokens is associated with a respective subportion of the portion of the video clip.

14. An apparatus for non-fungible token processing, comprising:
a memory; and
one or more processors coupled to the memory, the one or more processors being configured to:
identify a trigger for generating a non-fungible token associated with a video clip;
extract a portion of the video clip in response to identifying the trigger;
generate the non-fungible token corresponding to the portion of the video clip; and
output the non-fungible token for hosting on a platform.

15. The apparatus of claim 14, wherein, to identify the trigger, the one or more processors are configured to receive a user input associated with the video clip.

16. The apparatus of claim 14, wherein, to identify the trigger, the one or more processors are configured to determine than an event has occurred in the video clip.

17. The apparatus of claim 14, wherein the trigger associated with the video clip is identified while the video clip is being streamed live.

18. The apparatus of claim 14, wherein a duration of the extracted portion of the video clip is based on a type of the trigger.

19. The apparatus of claim 14, wherein the one or more processors are further configured to augment the portion of the video clip based on user input, wherein the non-fungible token is generated based on the augmented portion of the video clip.

20. A non-transitory computer-readable medium having instructions stored thereon, which when executed by one or more processors, cause the one or more processors to:
identify a trigger for generating a non-fungible token associated with a video clip;
extract a portion of the video clip in response to identifying the trigger;
generate the non-fungible token corresponding to the portion of the video clip; and
output the non-fungible token for hosting on a platform.
